(19) United States
(12) Patent Application Publication
(10) Pub. No.: US 2015/0112802 A1
(43) Pub. Date: Apr. 23, 2015

(54) METHOD AND SYSTEM FOR DELIVERING TARGETED MESSAGES BASED ON TRACKED TRANSACTION DATA

(71) Applicant: MasterCard International Incorporated, Purchase, NY (US)

(72) Inventors: Po Hu, Norwalk, CT (US); Jean-Pierre Gerard, Croton-On-Hudson, NY (US)

(73) Assignee: MasterCard International Incorporated, Purchase, NY (US)

(21) Appl. No.: 14/061,122

(22) Filed: Oct. 23, 2013

(51) Int. Cl. G06Q 30/02

(52) U.S. Cl. CPC G06Q 30/0255
USPC 705/14.53

(57) ABSTRACT

A card (e.g., a payment card such as a credit card, debit card, gift card, or any other electroncially readable card) of a user is electronically read at an automated teller machine (ATM), to determine card data identifying an account of the user. Based on the card data, a promotional message is automatically selected (e.g., by a computer processor) from a database comprising a plurality of promotional messages. The selected promotional message is targeted to the user. The selected promotional message is outputted to the user at the ATM.

### FIELD

Aspects of the present disclosure relate in general to automated, targeted delivery of promotional materials to individuals, and more particularly to delivering targeted content to consumers based on tracked transaction data.

### BACKGROUND

In contemporary society, payment cards (e.g., debit cards, charge cards, or credit cards) are convenient for a variety of financial tasks. With the prevalence of merchants that accept debit, charge, or credit cards as a form of payment, consumers have grown accustomed to making various types of transactions using such cards. For example, when a consumer presents a card to a merchant for payment, data encoded on the card can be read by a machine and then processed to charge or debit an account of the consumer. A person can also use a card to withdraw cash, deposit checks, perform account maintenance tasks (e.g., transfer money from one account to another), or perform other tasks at an automated teller machine (ATM). Whether cards are used for payment, e.g., at a point of sale (POS) terminal, or for other tasks such as withdrawing cash, the role of the card is similar in terms of storing and outputting data that can be used to access and update a cardholder's account.

### SUMMARY

In some embodiments, a card (e.g., a payment card such as a credit card, debit card, gift card, or any other electroncially readable card) of a user is electronically read at an automated teller machine (ATM), to determine card data identifying an account of the user. Based on the card data, a promotional message is automatically selected (e.g., by a computer processor) from a database comprising a plurality of promotional messages. The selected promotional message is targeted to the user. The selected promotional message is outputted to the user at the ATM.

In some embodiments, a card of a user is automatically read to determine card data identfying an account of the user. Based on the card data, a model score of the user is determined, e.g., by a computer processor. The model score is an indicator of a likelihood of an interest, a future activity, or a future transaction of the user. Based on the model score, a promotional message is automatically selected (e.g., by a computer processor) from a database comprising a plurality of promotional messages. The selected promotional message is outputted to the user. A computer processor (e.g., of a transaction detection module) automatically detects that the user used the card for a transaction that occurred after the outputting of the selected promotional message. The model score of the user is updated in response to the detected transaction.

In some embodiments, a system includes a transaction database, a scoring engine, and a marketing server. The transaction database includes transaction data associated with a plurality of transactions made by respective users using respective cards. The scoring engine includes a computer processor and model data stored in a model database coupled to the processor. The scoring engine is configured to generate, based on the transaction data received from the transaction database, a model score for each user, wherein said model score is an indicator of a likelihood of an interest, a future activity, or a future transaction of the corresponding user. The scoring engine is also configured to receive identification information associated with a card of one of the users, and, based on the identification information, output the model score associated with that user. The marketing server includes a marketing database comprising a plurality of promotional messages, and a processor configured to select one of the promotional messages based on the model score outputted by the scoring engine.

### BRIEF DESCRIPTION OF THE DRAWINGS

The following will be apparent from elements of the figures, which are provided for illustrative purposes and are not necessarily to scale.

FIG. 1 is a block diagram in accordance with some embodiments of the present disclosure.

FIG. 2 is a flow diagram in accordance with some embodiments.

FIG. 3 is a flow diagram of a modeling framework in accordance with some embodiments.

FIG. 4 is a flow diagram of a process in accordance with some embodiments.

FIG. 5 is a flow diagram of a process in accordance with some embodiments.

### DETAILED DESCRIPTION

This description of the exemplary embodiments is intended to be read in connection with the accompanying drawings, which are to be considered part of the entire written description.

Various embodiments of the present disclosure expand the scope of tasks for which cards such as payment cards may be used. By considering cards not just as a mechanism for consummating a present transaction (e.g., a purchase or a withdrawal of money from an ATM) but as a tool for accessing relevant information including information about past transactions, various embodiments facilitate the efficient delivery of targeted content to users.

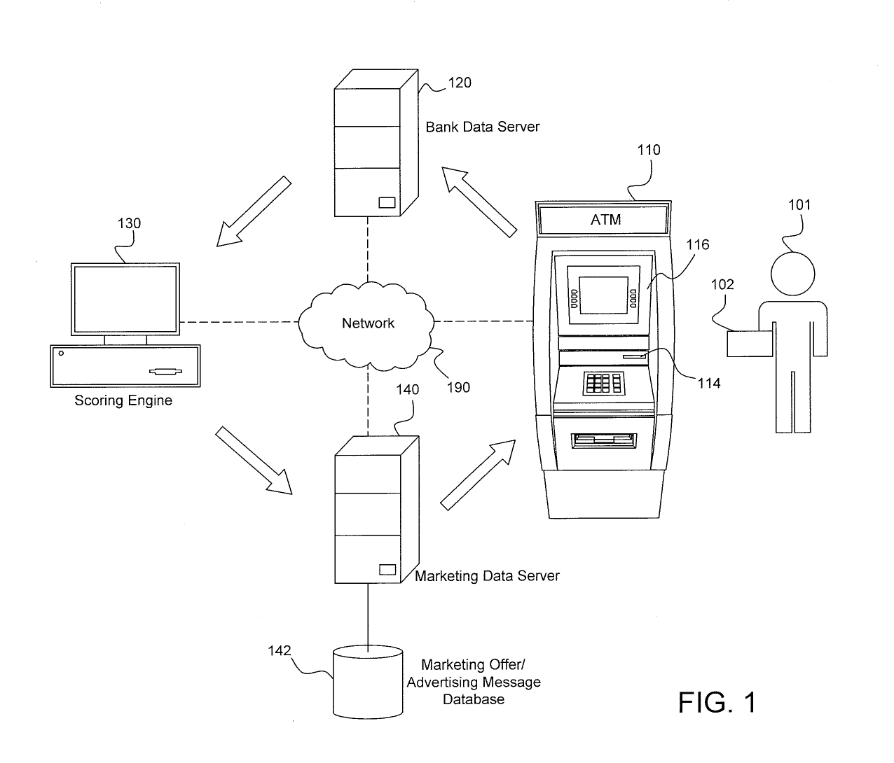

FIG. 1 is a block diagram in accordance with certain embodiments of the present disclosure. A user 101 has a card 102, which may be a credit card, debit card, or similar payment card that has encoded thereon data regarding the cardholder or an account of the cardholder. User 101 may also be referred to as a cardholder, consumer, or simply a person, as one of ordinary skill readily understands. Additional users (not shown) also have respective cards, and each user's card is a mechanism for targeting promotional messages based on which user's card is presented.

User 101 presents card 102 at a card reader 114 of a machine 110 such as an automated teller machine. Although an ATM is described herein as an example, machine 110 may be any other type of apparatus that includes a card reader 114 and a display 116, a printer, a speaker, or another message delivery mechanism. In an example involving an ATM, user 101 may use card 102 in order to withdraw cash, check the status of an account, to transfer money between accounts, or for any other transaction.

Whereas the display 116 of a conventional ATM typically only displays information regarding the transaction currently being performed (e.g., the status of a cash withdrawal process, or the available balance in a checking or savings account), the display 116 in various embodiments may be used to display targeted content, e.g., promotional materials, to the user 101. The promotional materials may include any message that is visually perceptible. In some embodiments, speakers or other audio output mechanisms of machine 110 may be used to play an audio recording. Thus, the promotional message may include audio, video, or multi-media content in some embodiments.

Promotional messages can be delivered in other ways than on a display screen. For example, in some embodiments, a receipt printer of machine 110 may print a coupon containing an advertisement or an offer. A coupon containing a barcode may be printed, and the coupon may later be redeemed at a merchant (e.g., when the user visits the merchant to make a purchase). By scanning the barcode, the merchant can determine that the promotional message displayed at machine 110 was successful in influencing the user to visit the merchant.

After the card reader 114 has electronically read card data from card 102 identifying an account of user 101, machine 110 sends information directly or indirectly to a scoring engine 130 regarding the identity of that account or the identity of user 101. This card data may also be referred to as identification information. Scoring engine 130 includes a computer processor and model data stored in a model database coupled to the processor. In the example of FIG. 1, data is first sent from ATM 110 to a bank data server 120 to indicate a card number associated with card 102 or other identifying information that identifies card 102 and/or user 101, and that data is then sent to scoring engine 130. Based on this received information, the scoring engine determines at least one score for the user 101 according to a statistical model.

In some embodiments, the model score(s) indicate the likelihood that user 101 will have an interest in the future or will engage in an activity or transaction in the future. The model score may correspond to virtually any interest, activity, or transaction that may occur in the future. The model score may also encompass the likelihood that the user has a present interest or is engaged in an activity presently. As just a few examples, the model score may represent a probability that user 101 will buy a new car within the next year, or that she is presently or will subsequently be interested in cooking, or that she will have a child depart for college within the next five years. Any time period or single point in time can be used for the target model. As one of ordinary skill in the art recognizes, statistical modeling is capable of being adapted to almost all human and non-human endeavors and can generate forecasts of future events or conditions based on past and/or present data.

Based on the model score(s) transmitted to a marketing server 140, a promotional message is selected. In FIG. 1, a database 142 storing offers and/or advertisements is shown coupled to server 140, but database 142 may be internal to server 140 or may be accessible via an intermediate network connection. Additionally, in some embodiments, offers (e.g., offers by merchants for particular products) and advertisements (e.g., brand promotion messages not tied to a particular product being offered) can be stored separately from each other. Server 140 also includes a computer processor configured to select one of the promotional messages based on the model score outputted by the scoring engine 130.

The selected promotional message may be an offer or advertisement that user 101 is likely to be receptive to, as determined by the statistical modeling framework. For example, if scoring engine 130 determines that user 101 has a 0.95 probability (95% likelihood or chance) of having a baby within the next year, an advertisement for a baby stroller may be selected. The selected promotional message is transmitted to ATM 110 and displayed to user 101 via display 116. Thus, for example, user 101 who is managing her bank account at ATM 110 can view relevant promotional content. By using card information that user 101 expects to supply in any event (e.g., to engage in an ATM transaction), there is no additional inconvenience to the user. By using existing display capabilities (e.g., display 116), content can be delivered to the user efficiently. Because the user typically has to view the display anyway to consummate her ATM transaction, the probability that she will actually view the delivered promotional content is high.

The communication links between the components shown in FIG. 1 may be achieved using a network 190, which may be include internet or an intranet. Any communication technique known to one of ordinary skill in the art may be used.

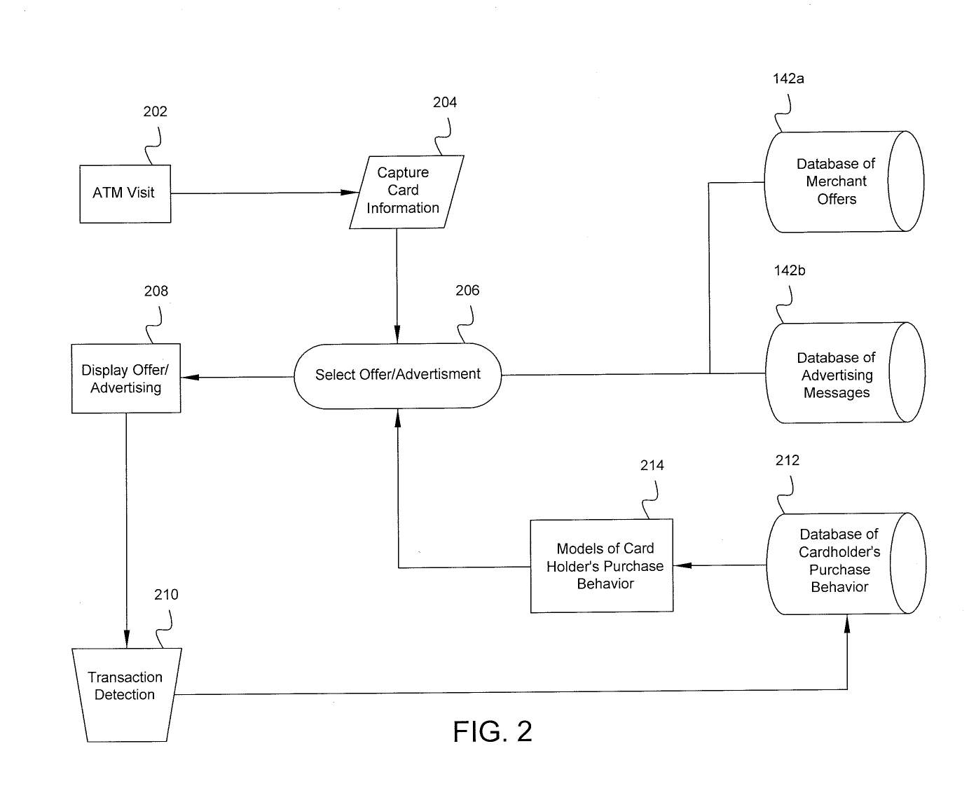

FIG. 2 is a flow diagram in accordance with some embodiments of the present disclosure. As described above, card data may be captured from an ATM visit (block 202). After a promotional message is selected (block 206) (e.g., from among various possible promotional messages at databases 142a and/or 142b) and displayed (block 208), additional processing may be implemented to enable a feedback loop as shown in FIG. 2. This closed loop configuration provides additional benefits that enable the model to be refined, as discussed below.

Suppose that after the user 101 leaves the ATM 110, the following week she uses the same card (card 102) to purchase a product from a merchant, as shown in FIG. 2 by transaction detection module 210. For example, user 101 may swipe card 102 at a card reader for this subsequent transaction, or she may enter the card information (e.g., credit card number, expiration date, and/or security code) at a computer.

This transaction may be detected as being associated with the same card 102 that was previously used when the promotional message was displayed to user 101. A database 212 of the purchasing behavior of user 101 is updated based on this later transaction. Database 212 may also be referred to as a cardholder transaction database, and this database includes transaction data associated with transactions made by various users with respective cards. For example, database 212 may indicate that a first user (e.g., John) made purchases from merchants X and Y in the last month, and that a second user (e.g., Sally) made a purchase from merchant Z last week.

A model 214 (e.g., a statistical model of the user's purchasing behavior) is also updated based on the detected transaction. The updated model is then used to influence future offer/adverisement selection. Thus, the model is refined based on actual purchases, and the feedback enables increased accuracy in targeting promotional materials to users.

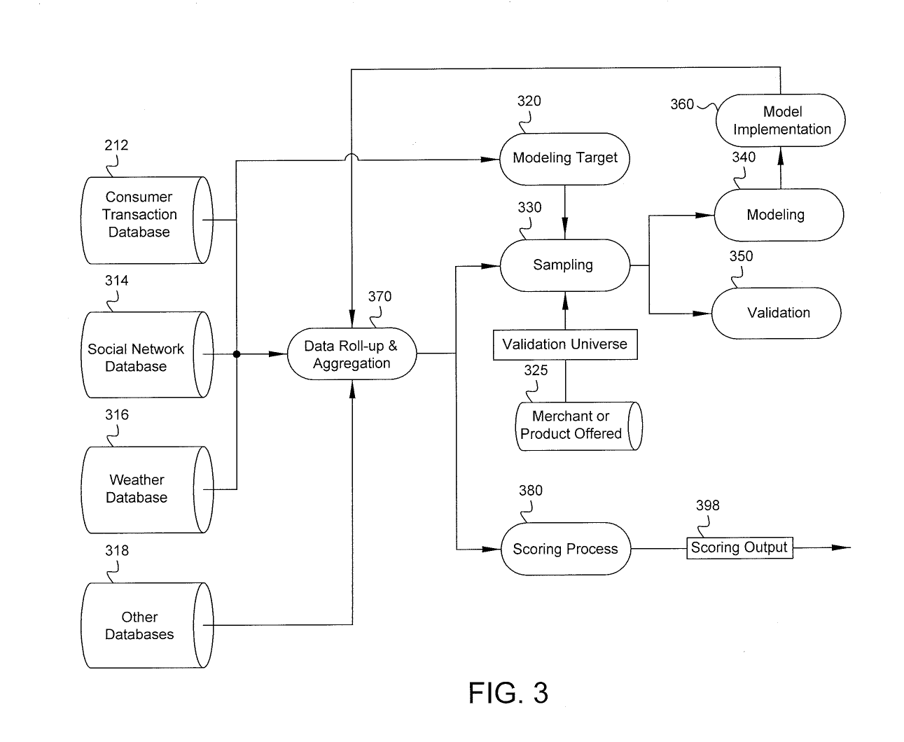

FIG. 3 is a flow diagram of a modeling framework in accordance with some embodiments. Processing illustrated in FIG. 3 may correspond to the modeling framework 214 of FIG. 2. The score(s) 398 which is/are fed to offer/advertisement selection module 206 (see FIG. 2) is/are the output of a statistical model. Various types of statistical models may be used to model future events, states, or conditions based on past and/or present data, as one of ordinary skill in the art readily understands. One example of modeling and score generation is described below, but one of ordinary skill understands that many other statistical techniques may be used as well.

Based on consumer transaction database 212 which contains information regarding past purchases by the user 101, future target activities, interests, or transactions may be modeled. For example, to target advertisements to new mothers, the relevant target model may correspond to the possible purchase of a crib in the next six months. Any other future activity, interest, or transaction may also be the subject of the target modeling. If a person recently used a credit card to purchase several products from baby goods suppliers, then that person may be likely to purchase a crib soon, for example.

A database 325 of merchants and/or products may provide a validation universe, i.e., a universe of possible merchants and/or merchants that may be analyzed in the context of modeling future activities. For example, if database 325 contains information regarding a particular bookseller, the statistical model may be used to determine the probability that an individual will buy a book from that bookseller in the future. Thus, database 325 may serve to define and/or bound the space that is to be modeled.

Typically, the quantity of data associated with modeling is large, which may strain computational resources, so sampling (block 330) may be used to reduce the data to a manageable size for analysis. In some instances, all samples may be used (i.e., no samples discarded). Some samples may be used for modeling (block 340) and other samples may be reserved for validation, e.g., quality control (block 350). The samples may be divided equally into modeling samples and validation samples, or any other ratio may be used. In some embodiments, all the samples obtained at one point in time are used for modeling, and all the samples obtained at another point in time are used for validation. The modeling samples are used to implement the model (block 360), e.g., using computer programs that implement the solution of equations for variables associated with the statistical framework.

An aggregation module 370 may aggregate data from several sources, e.g., consumer transaction database 212, social network database 314, and/or weather database 316, as well as from existing model data obtained from model implementation 360. The aggregated data represents a summary of the user's purchasing history and/or behavior as of a particular snapshot in time. Social network database 314 is optional and may provide information regarding the user's preferences and/or activities as revealed through the user's past participation in a social network (e.g., an online social network in which users may communicate and/or be linked to other uses). Weather database 316 is also optional and may provide information regarding past, present, or future weather conditions, which may be relevant for modeling the future. For example, if a person typically bought products from a coffeeshop whenever it rained over the last year, and if the weather forecast indicates that rain is likely tomorrow, then the person may be considered to be likely to purchase coffee tomorrow, so an advertisement for a coffee brand may be appropriate for targeted delivery. Other databases 318 may also be used to provide data for aggregation. For example, demographic databases may provide demographic information regarding a segment of the population or regarding cultural trends, any of which may be relevant for modeling future events.

After data has been aggregated at block 370, a scoring process 380 outputs one or more model scores that are indicative of some future condition relative to the user. Scoring processes are well known, and any suitable scoring process may be used. For example, the model score output may be a scalar score (e.g., 0.93) that is a computed probability that the user will buy shoes tomorrow. Or, the model score may be a vector (e.g., [0.2, 0.4, 0.9]) corresponding to the probabilities that tomorrow the user will buy shoes, ice cream, or a book, respectively. Or, the model score may be a vector corresponding to probabilities of engaging in some event or activity at various times (or time periods) in the future (e.g., within the next 3 months; within the next six months; and within the next 12 months). The model score may also be, for example, a matrix score that combines likelihoods of buying various products at various points in the future (e.g., with products along one dimension of the matrix and time periods or points along another dimension). In some embodiments, multiple scalar scores may be outputted instead of a vector or matrix score.

Referring back to FIG. 2, after the model score that is retrieved for a particular user based on captured card data, a promotional message is selected at block 206. An offer or advertisement that is a suitable match to the model score may be identified in various ways, as one of ordinary skill in the art understands. For example, if a model score is a scalar that exceeds a predetermined threshold, a certain advertisement may be displayed. Or, if a model score indicates a high likelihood that the user will engage in some activity but a matching advertisement has already been displayed recently to that user, then another closely matching advertisement may be selected. Or, a metric (e.g., a Euclidean distance metric) may be used to select the most appropriate message for a particular score. Depending on whether the model score is a scalar, vector, or a matrix, different algorithms may be used to select a promotional message, as one one of ordinary skill perceives.

The feedback shown in FIG. 2 enables marketers to accurately measure the response rate to offers or advertisements and to tailor marketing campaigns accordingly. For example, suppose certain individuals have been scored with an 85% likelihood (probability of 0.85) of being in the market within the next year for a new car. An advertisement for a car dealer may be displayed to some of those individuals with a red background on the advertisement, and a nearly-identical car advertisement with a blue background may be displayed to others. By measuring subsequent transactions, it may be determined that the red background made individuals 5% more likely than the blue background to buy from the car dealer in the future.

As another example, coupons may be printed and provided to individuals scoring above 0.9 (out of 1.0) in the target model. Redemption of the coupons can be tracked to determine that providing the offer (via the coupon) to individuals in one zip code is 10% more effective (for example) than providing the same offer to similarly scoring individuals in another zip code. Various other demographically motivated marketing experiments can be implemented as well.

Embodiments that involve the printing of a coupon provide advantages over traditional coupons printed at supermarkets and drugstores. Merchants such as supermarkets and drugstores typically track consumers' purchasing behavior through buyer loyalty programs (for which a card is typically issued), but such loyalty programs only enable the merchant to track purchases made at that merchant. In contrast, embodiments of the present disclosure are more powerful and useful because they enable transactions to be tracked across all merchants. This is because the mechanism that is used to associate and track purchases (e.g., debit/credit cards) is usable at various merchants, unlike merchant-specific loyalty cards. Such broad tracking functionality provided in various embodiments, and particularly the targeting of promotional content based on such tracked data, has not previously been available.

As discussed previously, ATMs are only one example of machines at which targeted content can be delivered. Any machine that has a card reader can read card data to identify an account of the user. For example, any point of sale terminal with a card reader at a gas station, supermarket, drugstore, or any other merchant, can be used to capture card data. Any machine that has a display, speakers, printer, or similar output capabilities can be used to deliver the targeted content. For example, machines at parking garages are commonly used to validate parking stubs. Those machines automatically read credit/debit cards and print out receipts, and thus they can be used to deliver targeted content in accordance with embodiments of the present disclosure.

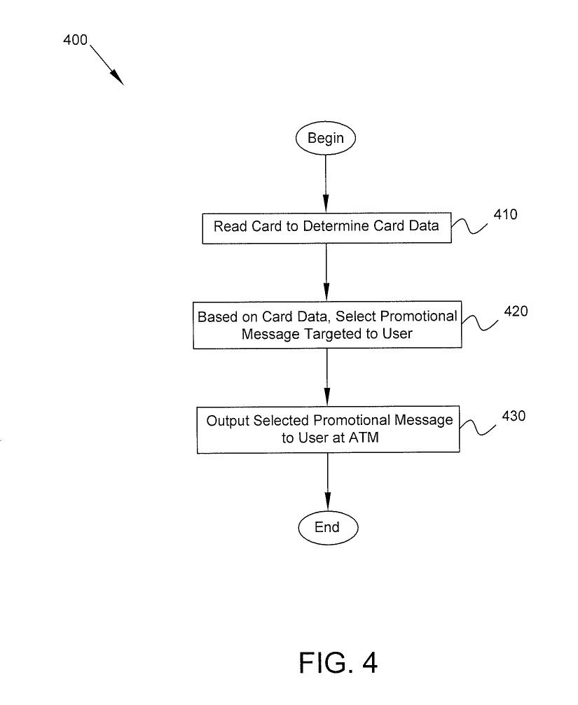

FIG. 4 is a flow diagram of a process in accordance with some embodiments. After process 400 begins, a card of a user is electronically read (block 410) at an automated teller machine (ATM), to determine card data identifying an account of the user. Based on the card data, a promotional message is automatically selected (e.g., by a computer processor) (block 420) from a database comprising a plurality of promotional messages. The selected promotional message is targeted to the user. The selected promotional message is outputted to the user at the ATM (block 430).

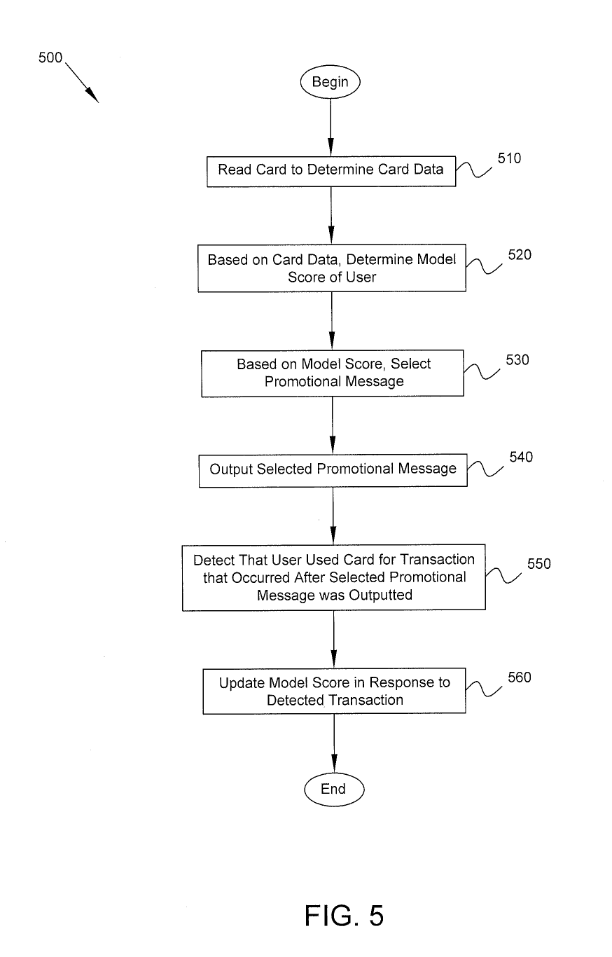

FIG. 5 is a flow diagram of a process in accordance with some embodiments. After block 500 begins, a card of a user is automatically read (block 510) to determine card data identfying an account of the user. Based on the card data, a model score of the user is determined, e.g., by a computer processor (block 520). The model score is an indicator of a likelihood of a future interest, future activity, or future transaction of the user. Based on the model score, a promotional message is automatically selected (e.g., by a computer processor) from a database comprising a plurality of promotional messages (block 530). The selected promotional message is outputted to the user (block 540). A computer processor (e.g., of a transaction detection module) automatically detects (block 550) that the user used the card for a transaction that occurred after the outputting of the selected promotional message. The model score of the user is updated (block 560) in response to the detected transaction.

It is understood by those familiar with the art that the system described herein may be implemented in hardware, firmware, or software encoded on a non-transitory computer-readable storage medium.

The systems and processes are not limited to the specific embodiments described herein. In addition, components of each system and each process can be practiced independent and separate from other components and processes described herein. Each component and process also can be used in combination with other assembly packages and processes.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method for delivering targeted content, the method comprising:
at an automated teller machine (ATM), electronically reading a card of a user to determine card data identifying an account of the user;
based on the card data, automatically selecting a promotional message from a database comprising a plurality of promotional messages, wherein the selected promotional message is targeted to the user; and
outputting the selected promotional message to the user at the ATM.

2. The method of claim 1, wherein the selected promotional message is a promotional message identified as a probable match to an interest, activity, or transaction of the user.

3. The method of claim 2, wherein the selected promotional message is identified as a probable match to a future interest, future activity, or future transaction of the user associated with a predetermined time period in the future.

4. The method of claim 1, further comprising automatically detecting that the user used the card for a transaction that occurred after the displaying of the selected promotional message.

5. The method of claim 4, wherein the transaction is a purchase of a product from a merchant, and the promotional message includes at least one of an offer for the product, an advertisement for the merchant, and an advertisement for the product.

6. The method of claim 4, further comprising determining a model score of the user, the model score being an indicator of a likelihood of a future interest, future activity, or future transaction of the user;
wherein the promotional message is selected based on the model score.

7. The method of claim 6, further comprising updating the model score of the user based on the transaction.

8. The method of claim 6, wherein the model score includes a scalar score.

9. The method of claim 6, wherein the model score includes a vector score corresponding to a plurality of likelihoods associated with respective products.

10. The method of claim 6, wherein the model score includes a vector score corresponding to likelihoods associated with a product at a plurality of time periods in the future.

11. The method of claim 6, wherein the model score includes a matrix score corresponding to likelihoods associated with a plurality of products and with a plurality of time periods in the future.

12. A method for delivering targeted content, the method comprising:
electronically reading a card of a user to determine card data identfying an account of the user;
based on the card data, determining a model score of the user, the model score being an indicator of a likelihood of an interest, a future activity, or a future transaction of the user;
based on the model score, automatically selecting a promotional message from a database comprising a plurality of promotional messages;
outputting the selected promotional message to the user;
automatically detecting that the user used the card for a transaction, wherein the transaction occurred after the outputting of the selected promotional message; and
updating the model score of the user in response to the detected transaction.

13. The method of claim 12, wherein the card is read at an automated teller machine (ATM), and the selected promotional message is outputted at the ATM.

14. A system comprising:
a transaction database including transaction data associated with a plurality of transactions made by respective users using respective cards;
a scoring engine including a computer processor and model data stored in a model database coupled to the processor, the scoring engine configured to:
generate, based on the transaction data received from the transaction database, a model score for each user, wherein said model score is an indicator of a likelihood of an interest, a future activity, or a future transaction of the corresponding user,
receive identification information associated with a card of one of the users, and
based on the identification information, output the model score associated with said one user; and
a marketing server including:
a marketing database comprising a plurality of promotional messages, and
a processor configured to select one of the promotional messages based on the model score outputted by the scoring engine.

15. The system of claim 14, further comprising a display module configured to cause the selected promotional message to be displayed on a screen.

16. The system of claim 15, wherein the screen is the screen of an automated teller machine (ATM).

17. The system of claim 15, further comprising a transaction detection module configured to automatically detect that said one user used the card for a transaction that occurred after the selected promotional message was displayed on the screen.

18. The system of claim 17, wherein the transaction that occurred after the selected promotional message was displayed is a purchase of a product from a merchant, and the selected promotional message includes at least one of an offer for the product, an advertisement for the merchant, and an advertisement for the product.

19. The system of claim 17, wherein the scoring engine is configured to update at least one model score associated with said one user, based on the automatic detection that said one user used the card for the transaction that occurred after the selected promotional message was displayed.

20. The system of claim 14, further comprising a printer configured to cause the selected promotional message to be printed on a coupon.
